(19) United States
(12) Patent Application Publication
(10) Pub. No.: US 2010/0122652 A1
(43) Pub. Date: May 20, 2010

(54) Mourning Flag

(76) Inventors: Michael J. Schofield, Escondido, CA (US); Harry Plowden, II, San Marcos, CA (US)

Correspondence Address: RUTH EURE, 4795 EDISON AVENUE, BOULDER, CO, 80301, US

(21) Appl. No.: 12/589,706

(22) Filed: Oct. 27, 2009

Related U.S. Application Data
(60) Provisional application No. 61/197,377, filed on Oct. 27, 2008.

(51) Int. Cl. G09F 17/00

(52) U.S. Cl. 116/173

(57) ABSTRACT

A specially designed flagpole designated as the Mourning Flag, comprising two distinct features which set this product apart from standard mounted flag poles available on the market. Firstly, positioned at the base of the Mourning Flag pole is a durable metal swing rod, configured expressly to enable users to adjust the angling of the pole in order to lower the pole during national days of mourning. Most notably, the pole itself comprises a telescoping extension, incorporated into the design of the distal end of the pole and hidden flush within the pole when not in use, easily pulled outward from the pole to extend the length of the pole several feet. As such, when this telescoping extension is accessed, it creates the effect that the flag was positioned at half staff, as opposed to being hung in the standard fashion, on the end of the flag pole. In an alternative embodiment, a decorative eagle or similar ornamental topper can be integrally attached to the end of the Mourning Flag pole, adding a festive patriotic touch to the overall display.

### CLAIM OF PRIORITY

This patent application claims priority under 35 USC 119 (e) (1) from U.S. Provisional Patent Application Ser. No. 61/197,377 filed Oct. 27, 2008, by Harry Plowden, II entitled, “Mourning Flag.”

### FIELD OF THE INVENTION

The present invention pertains to the field of flag poles, and more specifically to the field of adjustable flag poles.

### BACKGROUND OF THE INVENTION

The prior art has put forth several designs for adjustable flag poles. Among these are:

U.S. Pat. No. 4,918,896 to Wiese describes a telescoping flag pole. U.S. Pat. No. 5,044,301 to Peters and Melton describes an automatic flag unfurler.

U.S. Pat. No. 5,572,835 to Atkins and Manfredi describes a telescoping flag pole comprising rotatable flag engaging rings concentrically disposed on the main tubular segment.

None of these prior art references describes the present invention.

### SUMMARY OF THE INVENTION

It is an object of the present invention to provide a flag pole which has a “half mast” setting for easily displaying a flag at half staff.

A national symbol of enduring freedom is the American flag. Representing the struggle for independence, the unity of our nation and the liberty shared by the American people, the United States flag is an inspiration during times of national hardship and a constant reminder of the valor and devotion of those who have sacrificed their lives for our nation. Known as “the Stars and Stripes” or “Old Glory”, the American flag has flown on battlefields, atop government buildings, in front of schools and even on the moon. Today, more than ever before, American citizens are embracing the flag and displaying with pride this glorious symbol of freedom.

Similarly, state flags and those of various countries and regions, offer consumers a simple means of celebrating their own, personal heritage. Flying a native flag provides persons of various races and origins a simple sense of cultural pride and showcases unity for others in their community.

While proudly displaying the flag in front of the home offers consumers an easy means of showing their patriotism and respect for their country, doing so is not without drawbacks. Specifically, flag owners who utilize wall mounted flag poles are frustrated to find that they cannot lower their flag to half staff during national days of mourning or remembrance. Throughout the year, there are official dates such as Memorial Day or Pearl Harbor Remembrance Day, when the flag should be flown at half staff. Only the president of the United States or the governor of the state may order the flag to be at half-staff to honor the death of a national or state figure. While flags mounted on upright flag poles can be easily lowered to half staff, there is really no way to lower a flag mounted on a horizontal pole. For flags that can't be lowered, such as those on many homes, the American Legion says that attaching a black ribbon or streamer to the top of the flag is an acceptable alternative. However, many consumers feel that this is hardly a respectable remembrance.

### BRIEF DESCRIPTION OF THE DRAWINGS

FIG. 1 is a side view of the flag pole of the present invention displaying a flag in the standard position.

FIG. 2 is a side view of the flag pole of the present invention illustrating the adjustment mechanism for displaying a flag at half staff.

FIG. 3 is a side view of the present invention displaying a flag in the half staff position.

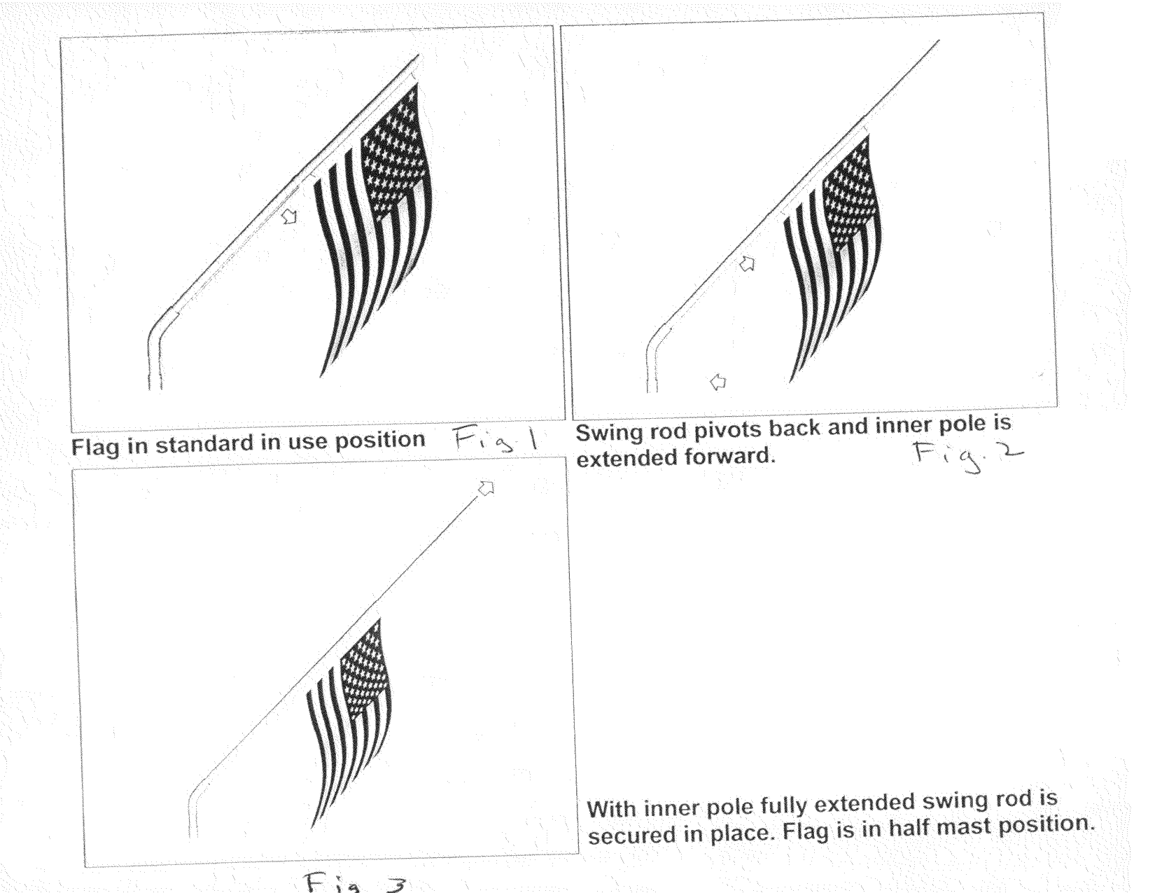

### DETAILED DESCRIPTION OF THE INVENTION

Having recognized the potential for a modification to the design of wall mounted flag poles which enables consumers to respectively lower flags displayed on these poles to half staff, the present invention was invented, and is referred to hereinafter as the Mourning Flag. Simply stated, the Mourning Flag is a specially designed flag pole which can be easily adjusted to “lower” an attached flag to half staff. Manufactured of polished aluminum or stainless steel material, the Mourning Flag is produced in a variety of sizes to accommodate various display needs. A simple mounting bracket is included to be secured to the side of a banister, column or side of the home via threaded bolts or screws. Positioned on the front of this bracket is a contoured niche, designed expressly to accommodate the Mourning Flag pole. The flag pole itself boasts two distinct features which set this product apart from standard mounted flag poles available on the market. Firstly, positioned at the base of the Mourning Flag pole is a durable metal swing rod, configured expressly to enable users to adjust the angling of the pole in order to lower the pole during national days of mourning. Most notably, the pole itself comprises a telescoping extension, incorporated into the design of the distal end of the pole and hidden flush within the pole when not in use, easily pulled outward from the pole to extend the length of the pole several feet. As such, when this telescoping extension is accessed, it creates the effect that the flag was positioned at half staff, as opposed to being hung in the standard fashion, on the end of the flag pole. In an alternative embodiment, a decorative eagle or similar ornamental topper can be integrally attached to the end of the Mourning Flag pole, adding a festive patriotic touch to the overall display.

Use of the Mourning Flag is very simple and straight forward. First, the user purchases an individual Mourning Flag pole sized appropriately for intended use. By way of example, a six foot Mourning Flag pole is appropriate for displaying a three foot by 5 foot flag. Once purchased, the user mounts the support bracket to the side of one's home or other building, inserting the Mourning Flag pole directly into the mounting bracket. In the event of a national day of mourning, or to commemorate another memorial event, the user simply adjusts the swing rod, lowering the pole several inches. The user then accesses the telescoping extension housed within the distal end of the pole, expanding the Mourning Flag pole several feet and thus creating the illusion that the hung flag was displayed at half staff. Typically this extension is about two to about three feet. After the designated period of mourning had past, the user simply returns the Mourning Flag pole to its standard configuration, displaying their flag per usual or removing and folding the flag properly and storing it until the next time it was displayed.

There are many significant benefits and advantages associated with the Mourning Flag. Foremost, the Mourning Flag offers consumers an easy means of respectfully displaying the flag at half staff. A specially designed mounted flag pole that can be easily adjusted in order to fly the flag at half staff, the Mourning Flag provides a patriotic alternative to removing a flag during national days of remembrance or mourning, simply because it cannot be lowered. As such, use of this flag pole enables consumers to respectively observe important national holidays where it is custom to display the flag at half staff, as well participate in national occasions of mourning. The Mourning Flag can be used to include national flags, state flags, corporate flags, for example. Manufactured of durable materials, the Mourning Flag will withstand harsh winds and the outdoor elements, with ease.

The Mourning Flag is a cleverly designed invention which offers consumers an easy means of displaying their patriotism. Simple to use, this cleverly designed, adjustable flag pole allows consumers to display the flag at half staff, in a respectable and attractive fashion.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An adjustable flagpole comprising:
a) a mounting bracket to be secured to the side of a banister, column or side of a home via threaded bolts or screws; wherein the front of the bracket comprises a contoured niche to accommodate a flag pole;
b) a durable metal swing rod positioned at the base of the flag pole, configured expressly to enable users to adjust the angling of the pole in order to lower the pole during national days of mourning.
c) wherein the pole itself comprises a telescoping extension, incorporated into the design of the distal end of the pole and hidden flush within the pole when not in use, easily pulled outward from the pole to extend the length of the pole two to three feet.

2. The flag pole of claim 1 further comprising a decorative eagle or similar ornamental topper integrally attached to the end of the flag pole.
